(19) United States
(12) Patent Application Publication
(10) Pub. No.: US 2010/0178944 A1
(43) Pub. Date: Jul. 15, 2010

(54) Automatic Email Account Creation

(76) Inventor: Nicolas Philippe Fodor, Belmont, CA (US)

Correspondence Address: MORGAN, LEWIS & BOCKIUS, LLP. (PA), 2 PALO ALTO SQUARE, 3000 EL CAMINO REAL, SUITE 700, PALO ALTO, CA, 94306, US

(21) Appl. No.: 12/354,747

(22) Filed: Jan. 15, 2009

(51) Int. Cl. H04W 4/00; G06F 15/16

(52) U.S. Cl. 455/466; 709/206; 455/412.1

(57) ABSTRACT

An email account is automatically created and associated with a communication device when an email is received for the communication device. The email is addressed using addressing information that includes a phone number associated with the recipient communication device, but does not include information identifying a network carrier associated with the recipient communication device. A messaging server causes an SMS to be sent to the recipient communication device. The SMS includes a notification that the email message has been received and includes a user-selectable link for accessing the email message. In response to receiving a selection of the user-selectable link, access is provided to the email message, for instance, using a Web-based email client at the recipient communication device.

### TECHNICAL FIELD

The disclosed embodiments relate generally to information delivery. More particularly, the disclosed embodiments relate to methods and systems for automatically creating an email account associated with a communication device when an email is received for the communication device.

### BACKGROUND

In telecommunication networks, such as cellular wireless networks, various messaging services are available to the subscriber/users, as alternative means of communicating at times when the initiating party and the targeted recipient may not be simultaneously available for or may not desire real time voice communication to take place. Such messaging services include email messaging, short message service (SMS) text messaging, multi-media messaging service (MMS), and so on. Some of these services are carrier, provider, network or platform dependent (collectively referred hereinafter as “network dependent,” as opposed to network independent), and some are user device dependent. Network dependent refers to messaging services that would work in one network (e.g., carrier, provider, platform or physical network) but not another, because of differences in operating protocols, parameters, specification, limitations, and other characteristics among the different carriers, providers, platforms, or physical networks. Such differences may include incompatibilities arising from underlying technologies, communication frequencies, the communication platform including the underlying hardware and software that handles communication over a network communication protocol, and/or simply the physical or operational limitations imposed on network providers and/or carriers (e.g., email addressing syntax, such as email domain address), to distinguish their services.

SMS text messaging provides a convenient way of communicating short messages, and it is typically not network dependent. As long as a carrier offers SMS text messaging as a service to its customers, SMS text messaging is compatible over disparate cellular carrier networks. A sender in one network can send an SMS text message to a recipient in another network. Most cellular handsets are enabled with SMS text messaging functionality. However, a sender is typically required to use the text entry interface of his or her cellular phone to input his or her message, which may be inconvenient and tedious. Another option would be to use a cellular carrier's proprietary browser interface to send SMS text messages. However, this requires the sender's prior knowledge of both the recipient's cellular carrier and the web address for the carrier's proprietary browser interface, which necessarily requires additional efforts on the part of the sender and defeats the advantage of convenience of SMS text messaging.

Email messaging to a recipient on a cellular network requires an email address of the recipient (e.g., 1234567890@vtext.com), in which “1234567890” is the targeted recipient's cellular phone number, and “vtext.com” is the email domain unique to the particular cellular provider (e.g., verizon wireless). The sender can send emails from an email-enabled cellular phone of one cellular carrier to another email-enabled cellular phone of another cellular carrier, or from a device connected to the Internet (e.g., via wired or wireless communication) to an email-enabled cellular carrier. As long as various network providers provide for email services and user cellular phones are email-enabled, email messages may be sent and delivered as SMS text messages (sometimes referred as SMS email messaging) across different cellular carrier networks.

As can be appreciated, if the sender uses a cellular phone to write an email, it is often tedious and cumbersome to input the text entry. If the sender instead uses an Internet-connected device, such as a desktop or laptop computer, text entry would be more convenient via a keyboard. However, the sender still must have prior knowledge of the recipient's email address, which requires prior knowledge of the particular email domain name unique to the particular cellular carrier. Also, if the email message is received as an SMS, it could be truncated (since SMS is limited to 160 characters) and attachments cannot be sent. Therefore, it is desirable to provide a further improved messaging system that will further improve the ease of sending emails to a communication device.

### BRIEF DESCRIPTION OF THE DRAWINGS

For a better understanding of the aforementioned aspects of the invention, as well as additional aspects and embodiments thereof, reference should be made to the Description of Embodiments below, in conjunction with the following drawings in which like reference numerals refer to corresponding parts throughout the figures.

FIG. 1 is a block diagram illustrating a distributed computer system.

FIG. 2 is a block diagram illustrating an electronic messaging server.

FIG. 3 is a block diagram illustrating a recipient communication device.

FIGS. 4A-4C illustrate flow charts of processes for email delivery and automatic email account creation for a recipient communication device.

FIGS. 5A-5E illustrates examples of graphical user interfaces (GUIs) at a sender communication device and the recipient communication device.

FIG. 6 is a block diagram illustrating an example of a user information database according to some embodiments.

### DESCRIPTION OF EMBODIMENTS

Methods, systems, and user interfaces for automatically creating an email account associated with a communication device when an email is received for the communication device are described. Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications, and equivalents that are within the spirit and scope of the invention as defined by the appended claims.

Moreover, in the following description, numerous specific details are set forth to provide a thorough understanding of the embodiments. However, it will be apparent to one of ordinary skill in the art that the invention may be practiced without these particular details. In other instances, methods, procedures, components, and networks that are well known to those of ordinary skill in the art are not described in detail to avoid obscuring aspects of the embodiments.

While the embodiments described herein are particularly suitable for use in cellular communication systems, they may find use in other types of mobile or non-mobile communication systems that are capable of being addressed to for email messaging using a unique identifier, such as a phone number. Also, the embodiments described herein can find utility in a variety of implementations without departing from the scope and spirit of the invention. For example, the email messaging concept employed in embodiments may be applied to business and personal communications, and may be implemented by commercial as well as private communication networks incorporating a messaging server in accordance with some embodiments.

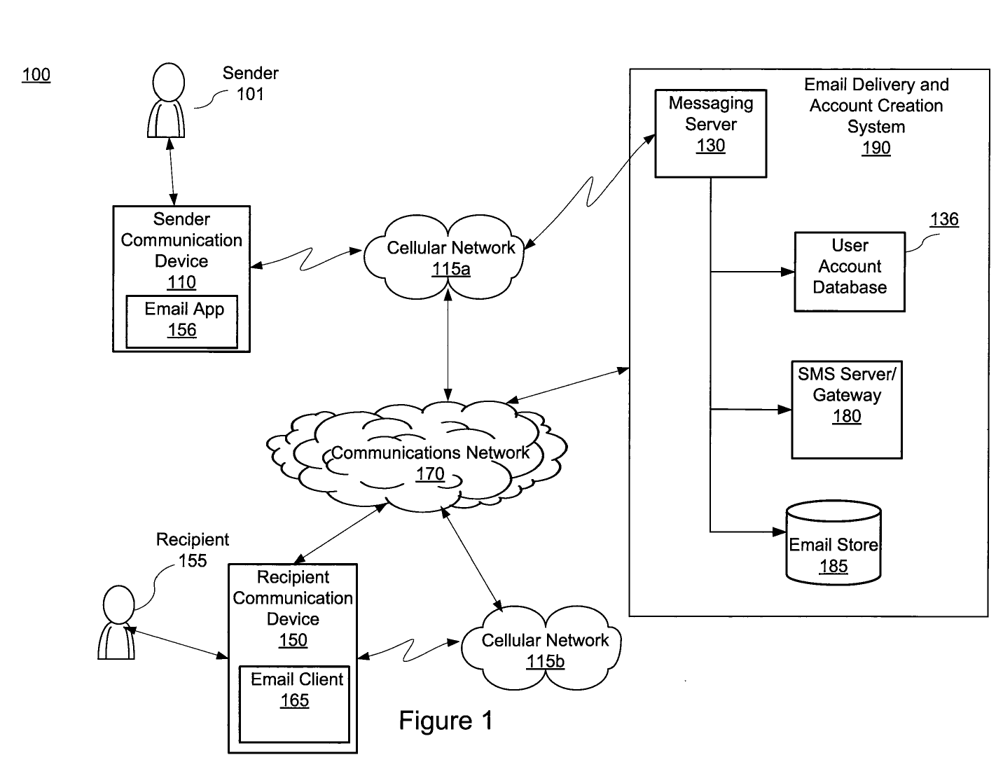

FIG. 1 is a block diagram illustrating a distributed computer system 100 according to some embodiments. FIG. 1 shows various functional components that will be referred to in the detailed discussion that follows. The system 100 may include a sender communication device 110 that is used by a sender 101 to send an email message to a recipient communication device 150 associated with a recipient 155.

The sender 101 may send the email message through any device 110 enabled with email functionality (e.g., a device enabled to communicate with an SMTP server), which may be a desktop information processing device (e.g., a desktop or laptop computer), an electrical or electronic device incorporating an information processing device enabled with email functionality and/or an Internet connection (e.g., a TV, TV set-top box, cable set-top box, satellite set-top box, telephone system, refrigerator having a built-in device to access the Internet, etc.), a portable and/or wireless device (e.g., a cellular phone, satellite phone, Voice over IP (VoIP) phone, portable computer, personal digital assistant (PDA), digital music play (e.g., MP3 player, iPod player, etc.)) that connects to the Internet or other communication networks.

In some embodiments, the sender 101 uses an electronic messaging application, such an email application 156, at the sender communication device 110 to send an email message that is addressed to the recipient 155 using a unique identifier, such as a phone number that is associated with the recipient communication device 150 (e.g., 1234567890). The phone number may include a country prefix. The sender 101 addresses an email message using the phone number to a messaging server (e.g., 1234567890@messagingservicedomainname.com), without having any knowledge of the carrier network 115b (e.g., AT&T, verizon, etc.) associated with the recipient communication device 150. In the examples described herein, the messaging server is provided by a company called Freedomail. The email message sent by sender 101 may include a data file attachment. Examples of a data file include a voice message, text document, a musical file, a picture file, a PDF file, an audio file, an executable file, and/or a multimedia file, to name a few.

Recipient communication device 150 can be any of a number of communication devices that have associated therewith a unique phone number (e.g., personal digital assistant, cellular telephone, gaming device, a fixed device such as a landline phone and a personal computer, to name a few, as well as a VoIP enabled device) and is capable of receiving an electronic message (e.g., an SMS, MMS, an instant message, a chat) and of accessing a communications network 170.

Sender communication device 110 and recipient communication device 150 are connected to a communications network 170, which can be any of a number of networks (e.g. Internet, intranet, local area network, wide area network, wireless network, wired network, optical network, etc.). Also shown in FIG. 1 are cellular network 115a and 115b, which connect sender communication device 110 and recipient communication device 150 respectively to communications network 170, in the case where the sender communication device 110 and recipient communication device 150 are any one of a cellular telephone, PDA or other device capable of using such a communications network 170. In some embodiments, sender communication device 110 and/or recipient communication device 150 need not connect over a cellular network. In some embodiments, cellular network 115a and 115b can be the same network.

In communication with the communications network 170 is an email delivery system and account creation system 190. System 190 includes a messaging server 130, which may be an SMTP, LMTP, SMPTD, POP, IMAP, ESMTP, or other similar server. The messaging server 130 can access a user account database 136 for storing user account information and an email store 185 for storing incoming email messages. Email delivery system and account creation system 190 also includes an SMS server/gateway 180. The SMS server/gateway 180 may be a short message service center (SMSC).

According to some embodiments, messaging server 130 receives an email message from sender 101 that is addressed to a recipient communication device 150. The addressing information includes a phone number associated with the recipient communication device 150, but does not include any carrier information. For instance, the addressing information does not include a domain name associated with a cell phone carrier (e.g., AT&T, verizon, etc.) associated with the recipient communication device 150. If no email account is associated with the recipient communication device 150 in user account database 136, messaging server 130 automatically creates an email account associated with the recipient communication device 150. The email message is stored in email store 185. Messaging server 130 causes an SMS to be sent to the recipient communication device 150 by SMS server/gateway 180. In some embodiments, other types of messaging (e.g., MMS, instant messaging, chat etc.) can be used. The SMS includes a notification that the email message has been received and includes a selectable link for accessing the email message. In response to receiving a selection of the selectable link, access is provided to the email message, for instance, using a email client 165 at the recipient communication device 150.

In some embodiments, fewer and/or additional modules, functions, or databases are included in the email delivery system and account creation system 190. In some embodiments, some or all of these modules, functions, or data bases may be combined dependent on the needs and capabilities of the communications network and the systems and/or devices being used therewith. The modules shown in FIG. 1 as being part of email delivery system and account creation system 190 represent functions performed in an embodiment.

Messaging Server 130 and Recipient Communication Device 150

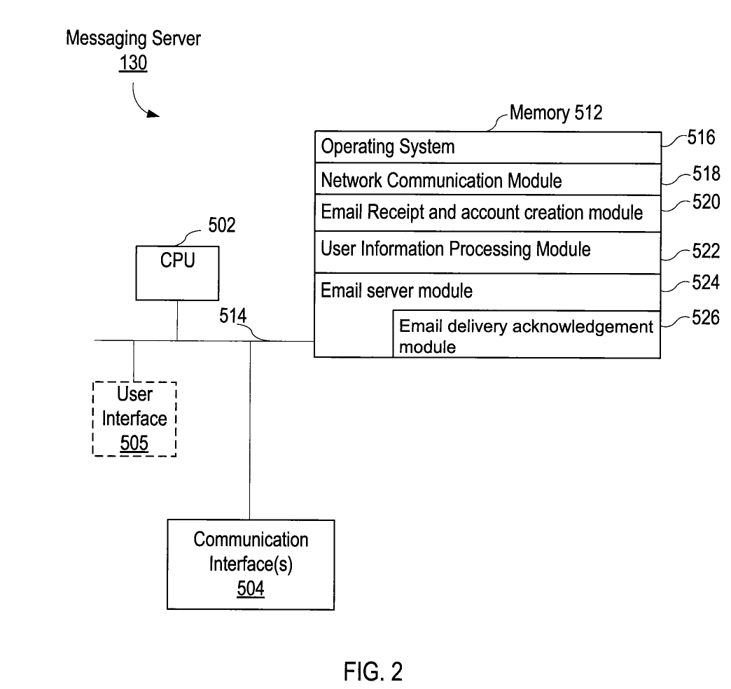

FIG. 2 is a block diagram illustrating a messaging server 130 in accordance with some embodiments. The messaging server 130 typically includes one or more processing units (CPU's) 502, one or more network or other communications interfaces 504, memory 512, and one or more communication buses 514 for interconnecting these components. The messaging server 130 optionally may include a user interface 505, for instance comprising a display device and a keyboard. Memory 512 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 512 may optionally include one or more storage devices remotely located from the CPU(s) 502. Memory 512, or alternately the non-volatile memory device(s) within memory 512, comprises a computer readable storage medium. In some embodiments, memory 512 stores the following programs, modules and data structures, or a subset thereof:
an operating system 516 that includes procedures for handling various basic system services and for performing hardware dependent tasks;
a network communication module 518 that is used for connecting the messaging server 130 to other computers via the one or more communication network interfaces 504 (wired or wireless) and one or more communication networks 150, such as the Internet, other wide area networks, local area networks, metropolitan area networks, and so on;
an email delivery and email account creation module 520 that receives electronic messages from senders (such as sender 101), causes an email account to be automatically created for the recipient using the recipient's phone number, and causes an SMS to be sent to a recipient;
a user information processing module 522 that accesses user account database 136 to determine user information and preferences and to determine whether to provide a user with access to a particular email; and
an email serve module 524 to service requests from a web-based email client 165 by accessing email store 185, and that may optionally include an email delivery acknowledgement module 526.

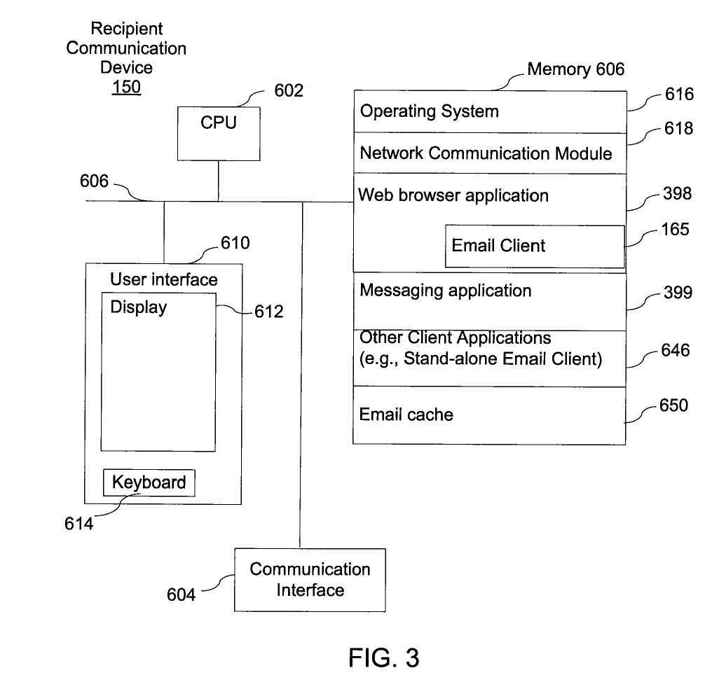

FIG. 3 is a block diagram illustrating a recipient communication device 150 in accordance with some embodiments. The recipient communication device 150 typically includes one or more processing units (CPU's) 602, one or more network or other communications interfaces 604, memory 606, and one or more communication buses 606 for interconnecting these components. The recipient communication device 150 includes a user interface 610 comprising a display device 612 and a keyboard 614. Memory 606 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. Memory 606, or alternately the non-volatile memory device(s) within memory 606, comprises a computer readable storage medium. In some embodiments, memory 606 stores the following programs, modules and data structures, or a subset thereof:
an operating system 616 that includes procedures for handling various basic system services and for performing hardware dependent tasks;
a network communication module 618 that is used for connecting the recipient communication device 150 to other computers via the one or more communication network interfaces 604 (e.g., wireless) and one or more communication networks, such as the cellular network 115b and/or communications network 170;
an Internet or WWW browser application 398;
a stand-alone email client or Web-based email client 165. The Web-based email client 165 is a thin client running inside the WWW browser application 398. In some embodiments, the Web-based email client 165 is constructed with just enough functionality to enable access to the messaging server 130 over communications network 170. A user's account, including mailbox(es), is maintained at messaging server 130 and the Web-based email client 165 accesses the mailbox(es) using standard Web protocol;
a messaging application 399 that is used by recipient 155 to send and receive SMS messages, including to receive a notification SMS that an email has been received;
other optional client applications 646; and
an email cache 650.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 512 (and memory 606) may store a subset of the modules and data structures identified above. Furthermore, memory 512 (and memory 606) may store additional modules and data structures not described above.

Although FIGS. 2 and 3 show a messaging server 130 and a recipient communication device 150 respectively, FIGS. 2 and 3 are intended more as functional description of the various features which may be present in a set of servers than as a structural schematic of the embodiments described herein. In practice, and as recognized by those of ordinary skill in the art, items shown separately could be combined and some items could be separated. For example, some items shown separately in FIG. 2 could be implemented on single servers and single items could be implemented by one or more servers. The actual number of servers used to implement a messaging server 130 and how features are allocated among them will vary from one implementation to another, and may depend in part on the amount of data traffic that the system must handle during peak usage periods as well as during average usage periods.

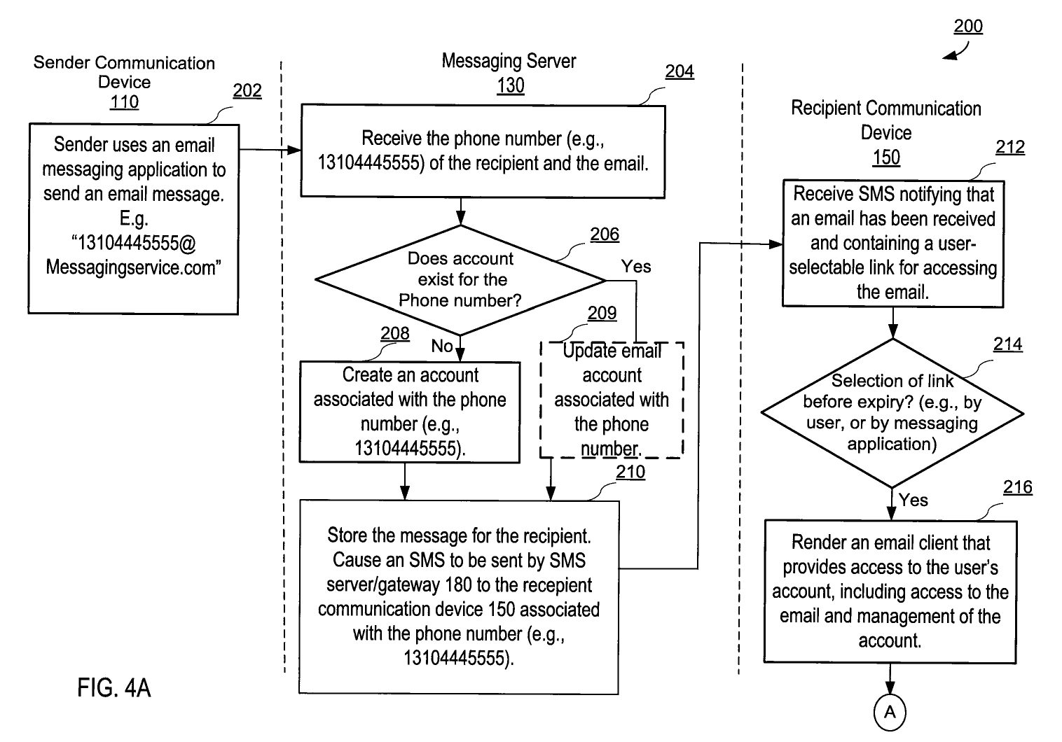

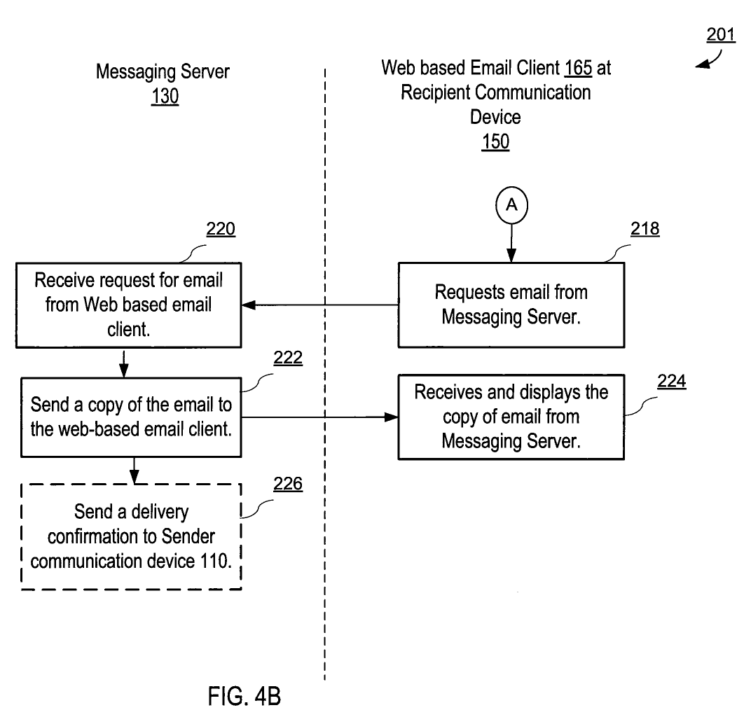

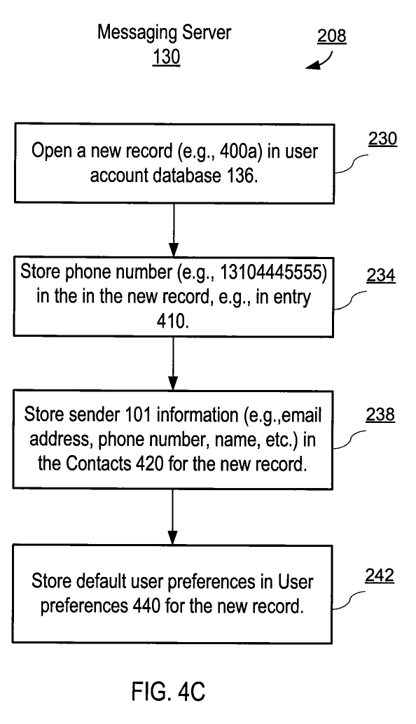

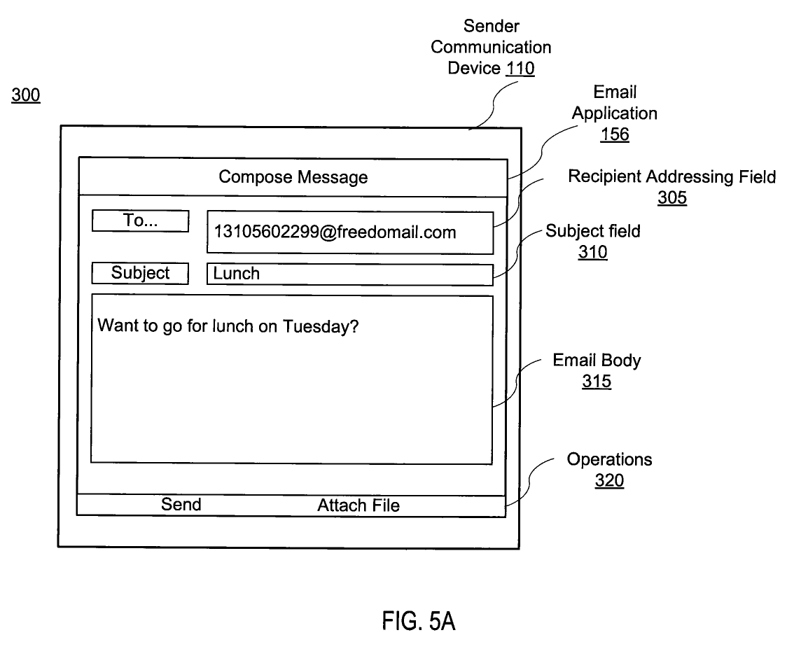

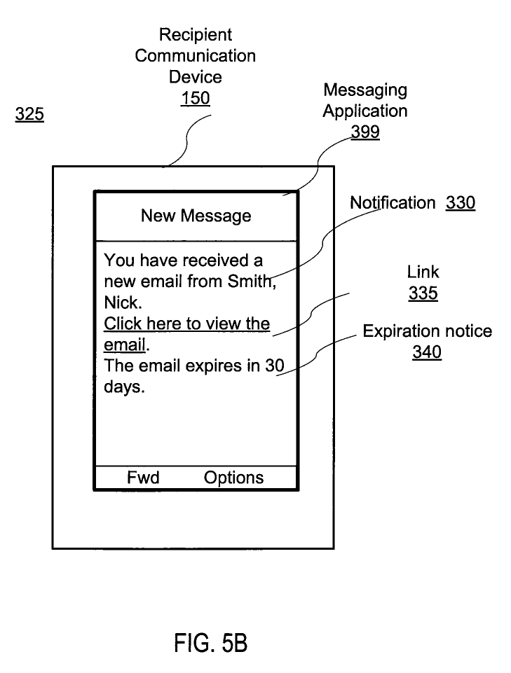

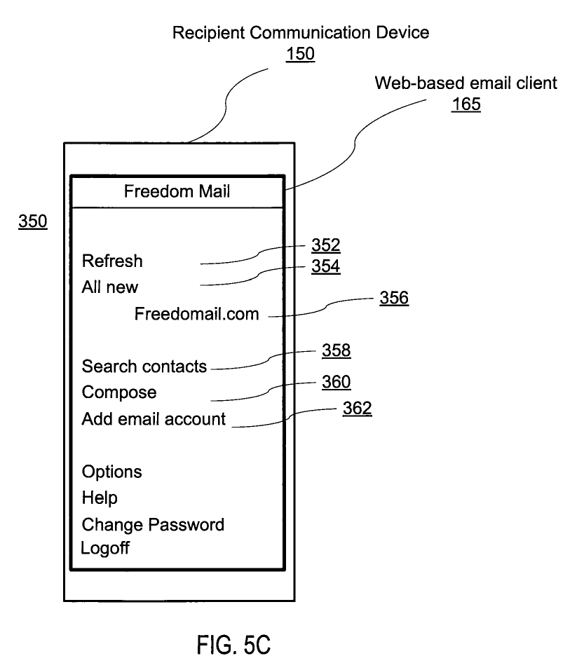

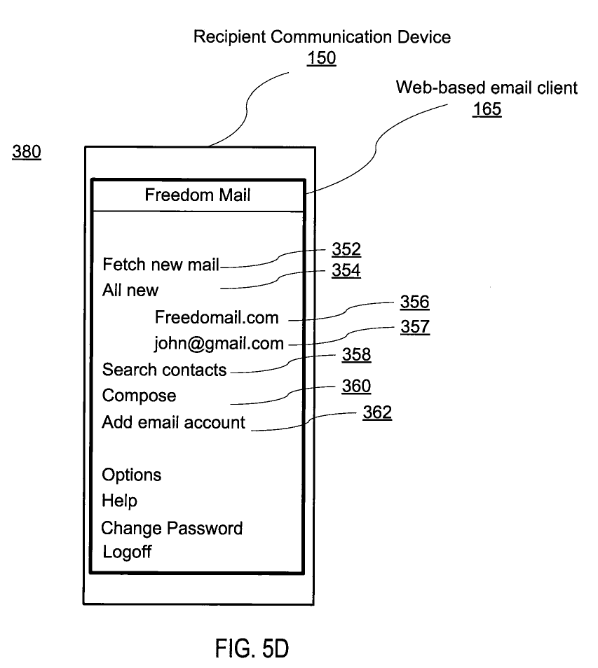

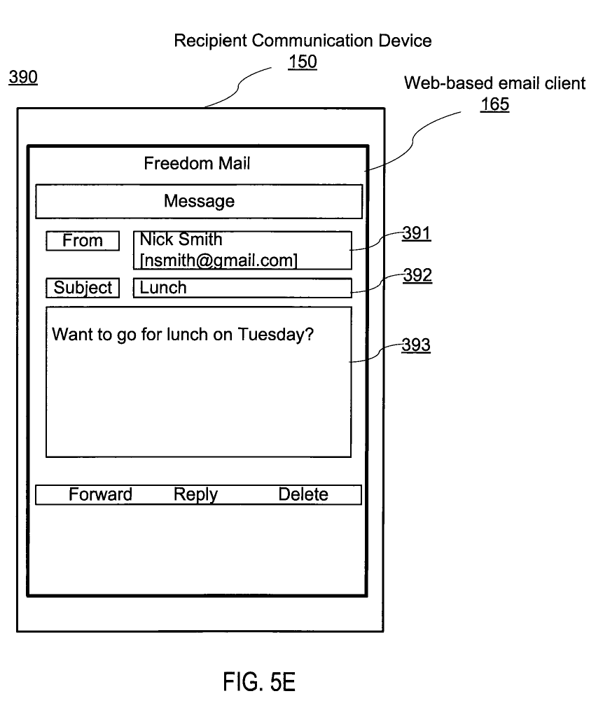

FIGS. 4A-4B illustrate flow charts of processes 200 and 201 for email delivery and automatic email account creation for recipient communication device 150. FIGS. 5A-5E illustrates examples of some of the corresponding graphical user interfaces (GUIs) at the recipient communication device 150.

At 202, sender 101 uses an email messaging application 156 at sender communication device 110 to send an email message to a recipient 155. FIG. 5A illustrates an example of a GUI 300 of a sender 101 using an email messaging application 156 at sender communication device 110 to send an email message to a recipient 155. GUI 300 includes a main recipient addressing field 305, where the sender 101 enters the recipient's addressing information. As illustrated in FIG. 5A, the recipient's addressing information is an email address of the form: “recipient's phone number@messaging service domain name.com.” In the example illustrated in FIG. 5A, the recipient's addressing information is 13105602299@freedomail.com, where freedomail is the messaging service domain name. Note that the sender 101 does not need to know or include any information regarding the carrier network (e.g., AT&T, verizon, etc.) associated with the phone number—13105602299.

GUI 300 includes a subject field 310, where the sender 101 may optionally enter the subject of the email message, e.g., “Lunch.” GUI 300 includes an email message body 315, where the sender 101 may optionally enter the body of the electronic message, e.g., “Want to go for lunch on Tuesday?” GUI 300 includes operations 320, including at least a “Send” button, which the sender 101 may use to send the email message. The “Send” button may be part of the GUI 300, or may be an actual button (hard or soft) on the sender communication device 110. Operations 320 may also include other operations, such as attaching a file to the email message.

Referring back to FIG. 4A, in some embodiments, optionally at 202, sender 101 explicitly requests a confirmation that the electronic message has been delivered to the receiving client 150. In other embodiments, sender 101 does not explicitly request delivery confirmation information.

At 204, messaging server 130 (e.g., the freedomail messaging server) receives the email message information, including header information including the address of the recipient (e.g., 13105602299), and the body of the message (e.g., “Lunch” “Want to go for lunch on Tuesday?”). At 206, messaging server 130 checks to see if an email account exists for the phone number (e.g., 13105602299) included in the email header information. In some embodiments, messaging server 130 checks to see if an email account exists for the phone number in the user account database 136. If no email account exists for the phone number in the user account database 136, at 208, the messaging server 130 initiates an automatic email account creation process for the phone number. If, at 206, an email account exists for the phone number in the user account database 136, the method continues to 210. Optionally, at 209, the messaging server 130 updates the already existing email account associated with the phone number. For example, the messaging server 130 updates the contact information for the email account using the sender's contact information (e.g., name, email address, and/or phone number).

At 208, the messaging server 130 automatically creates an email account for the phone number (e.g., 13105602299) included in the email header information. An email account creation process 208 is discussed further in reference to FIG. 4C. The email account is created without requiring any input from any user or entity associated with recipient 155 or recipient communication device 150. The newly created email account for the phone number (e.g., 13105602299) is stored in the user account database 136.

After creation of the email account for the phone number (or in some embodiments, in parallel to creation of the email account), at 210, messaging server 130 stores the email message information in email store 185 and associates the recipient's email account with the stored email. For instance, the email may be stored in the email store 185 along with account identification information, such as an account ID. The messaging server 130 also automatically causes an SMS to be sent by SMS server/gateway 180 to the recipient communication device 150 having the phone number included in the email header information. The SMS server/gateway 180 sends the SMS to the recipient communication device 150. At 212, the recipient communication device 150 receives the SMS. An example GUI 325 illustrating an SMS that may be received by the recipient communication device 150 and rendered by a messaging application 399 is illustrated in FIG. 5B.

The body of the SMS includes a notification 330 notifying the recipient 155 that a new email has been received. In some embodiments, notification 330 also includes information identifying the sender 101, such as the name of the sender 101 and/or the email address of the sender 101. The information identifying the sender 101 may be derived from the email header, and may include one or more of: a name associated with an email address used by the sender to send the email message, the email address used by the sender to send the email message, and a phone number associated with the sender communication device 110. In some embodiments, the phone number associated with the sender communication device 110 can be deduced from the email header or from the MSISDN (which is the telephone number to the SIM card in a mobile/cellular phone). In some embodiments, notification 330 also includes information from the body of the email, such as the email subject (if any), the email body (if any), or portions thereof (for instance, to make them fit inside the character limit on an SMS).

The body of the SMS includes a link 335 which can be selected/activated by recipient 155 to access the email. In some embodiments, the link 335 is user-selectable. In some embodiments, the link 335 may be selected/activated automatically, for instance by the messaging application 399 at the recipient communication device 150 that receives the SMS. The messaging application 399 may trap the SMS and automatically activate or open the link 335. In some embodiments, the link 335 includes information identifying the sender 101, such as the name of the sender 101, the email address of the sender 101, and/or the phone number of the sender 101.

The body of the SMS optionally includes an expiration notice 340 notifying the recipient 155 that the email expires in a pre-defined amount of time (e.g., 30 days), and cannot be accessed after that time.

Referring back to FIG. 4A, at 214, if recipient 155 selects the link 335 before the expiration of the pre-defined amount of time (if such a time is defined), then at 216, selection of the user-selectable link 335 renders an email client 165 at the recipient communication device 150. The email client 165 may be web-based or a stand-alone application that is opened at the recipient communication device 150. The email client 165 provides access to the email account associated with the phone number of the recipient communication device 150. The email client 165 provides access to the email received from the sender 101, and further enables recipient 155 to manage the email account. In some embodiments, optionally, at 216, the email client 165 only provides the said access upon user authorization. For instance, the email client 165 may require the user to provide a password, which may be set the first time the user views the email client 165 from the recipient communication device 150. In some embodiments, the password information is sent privately in the SMS so only the recipient 155 can have access to the newly created email account.

FIG. 5C illustrates an example GUI 350 that may be presented to recipient 155 at 216 upon selection of the link 335. GUI 350 may be presented in email client 165 that is Web-based and may include an icon and/or link 354 for fetching new mail. GUI 350 lists other email mailboxes registered with the recipient's phone number. Here, because this is the first time the recipient 155 is checking his email account, the only mailbox 356 is the one for freedomail. GUI 350 also provides other tools for managing the user's account, such as search contacts 358, compose email 360, an icon and/or link 352 to perform a refresh operation, and for adding email accounts 362.

A recipient 155 can add other email accounts using the link and/or icon for add email accounts 362. The recipient 155 can then access these added email accounts from the web-based email client 165. FIG. 5D illustrates a GUI 380, which is similar to GUI 350, except that GUI 380 displays two email mailboxes—one is the recipient's freedomail mailbox 356, and the other is the recipient's gmail mailbox 357 that has been added by the recipient 155. In some embodiments, recipient 155 can add up to a pre-defined number of other email mailboxes. In some embodiments, the recipient 155 can add up to five mailboxes.

Selection of icon and/or link 356 causes the Web-based email client 165 being rendered at the recipient communication device 150 to fetch emails for the recipient's freedomail mailbox associated with the phone number of the recipient communication device 150. This process is illustrated in FIG. 4B. At 218, upon selection of icon and/or link 356, Web-based email client 165 requests emails for the user's freedomail mailbox from messaging server 130. If the user had instead selected the icon and/or link 354, the Web-based email client 165 would request other emails for each email mailbox (e.g. freedomail mailbox and gmail mailbox) from messaging server 130. If the user had instead selected the icon and/or link 357, the Web-based email client 165 would request other emails for the user's registered gmail mailbox from messaging server 130. At 220, the messaging server 130 receives the request for emails from the Web-based email client 165, and at 222, the messaging server 130 serves the request. At 224, the Web-based email client 165 receives the requested emails from the messaging server 130 and displays the emails. The emails are displayed as emails in the Web-based email client 165, and not as text messages in a messaging application 399 at the recipient communication device 150. Further, any attachments to the emails can also be accessed. In some embodiments, instead of using an email client 165, an existing SMS or text messaging application (e.g., application 399) at the recipient communication device 150 is used to display the email.

FIG. 5E illustrates an example GUI 390 that may be presented to recipient 155 at 224. GUI 390 includes the email message received from sender 101, and displays the sender's email address 391, email subject 392, and email body 393. Web-based email client 165 enables the recipient 155 to perform actions on the email, such as forward, reply, save, delete, etc. Thus, instead of using an SMS as a delivery mechanism for the email body, Internet/email (data) is used, which thus allows the user to receive emails on his or her cell phone or other device. The user can also receive email attachments in this manner. Also, the recipient 155 is notified of the email's sender 101, and the recipient 155 can choose to access the email or not. In this way, the recipient 155 can choose not to view unwanted emails from undesirable senders.

In some embodiments, optionally, after serving a request for emails for the user's freedomail mailbox from the Web-based email client 165, the messaging server 130, at 226, sends a delivery confirmation to an email sender's communication device 110. In some embodiments, after causing the SMS to be sent by the SMS server/gateway 180 (at 210), the messaging server 130, at 226, sends a delivery confirmation to an email sender's communication device 110.

Account Management and Spam Regulation

The Web-based email client 165 provides a number of account management tools. One of these tools can be a tool for contact management, such as an “Add Your Friends” icon and/or link (not shown), which can be used by the user to add and/or delete contacts. In some embodiments, for spam regulation, the email addresses in the user's contact list constitute the user's freedomail mailbox white-list. In some embodiments, other email arriving at the user's freedomail mailbox will be discarded. The user's contacts are stored in the user account database 136.

The Web-based email client 165 enables the user to search contacts using link and/or icon 358, to compose new emails using compose function 360, and to add new email accounts (for instance, up to five) using add email account link and/or icon 362. The Web-based email client 165 may also provide other options, such as to change the user's password. to change the password the user enters upon logging in to the accounts on the web site, change time zone associated with the recipient communication device 150 so that email delivery scheduling corresponds to the user's specified location, and so on. The user's password information and the time zone information is stored in the user account database 136.

In some embodiments, the user can access the web-based email client 165 to restrict emails addressed using the recipient communication device 150 phone number to senders who are verified. For instance, a sender 101 may be required to have an email account with the messaging service (e.g., freedomail), and provide contact information (e.g., a sender phone number and/or email address), which is verified by the messaging service (e.g., freedomail). The recipient 155 can also forward email from other mailboxes to the recipient's freedomail mailbox 356.

In some embodiments, the recipient 155 can set up auto-forwarding of incoming emails to the recipient's freedomail mailbox 356 to one or more other mailboxes (e.g., gmail mailbox). In some embodiments, the recipient 155 can set up the auto-forwarding with or without the SMS notification. In some embodiments, for instance for spam regulation, the recipient 155 can block all SMS notifications.

Account Creation and User Information Database

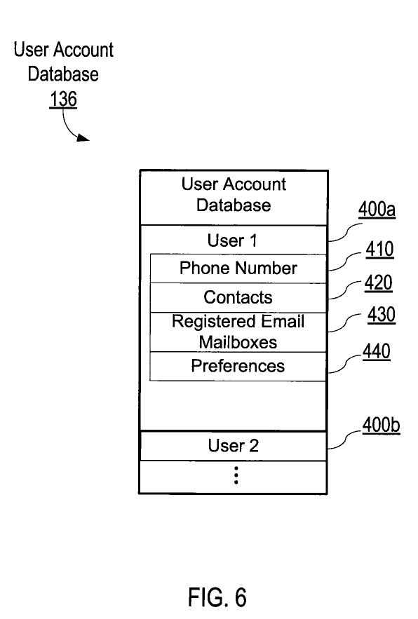

FIG. 4C is a block diagram illustrating an example process 208 of automatically creating an email account. FIG. 6 is a block diagram illustrating an example of a user account database 136 according to some embodiments. User account database 136 stores information about users 400. The information stored for a particular user (e.g., user 400a) may include one or more phone numbers 410 associated with the user's recipient communication device(s) 150, a user's contacts 420, a users' other registered email mailboxes (e.g., gmail mailbox) 430, and user preferences 440. User preference information 440 may contain various types of user information relating to user preferences, carrier settings, spam settings, password information, security information, restrictions on who can emails be received from, or any other information that might be used by the various embodiments.

At 230, upon receiving an email addressed to phone number for which no record of an account exists in the user account database 136, the messaging server 130 opens a new record (e.g., record 400a) in the user account database 136. At 234, the messaging server 130 stores the phone number to which the email is addressed in the phone entry 410 of the record 400a. At 238, the messaging server 130 stores the sender's contact information (e.g., name, email address, and/or phone number) in the contacts entry 420 of the record 400a. At 242, the messaging server 130 stores default preferences in the user preferences 440 of the record 400a.

Each of the methods described herein may be governed by instructions that are stored in a computer readable storage medium and that are executed by one or more processors of one or more servers or clients. Each of the operations shown in FIGS. 4A-4C may correspond to instructions stored in a computer memory or computer readable storage medium. For instance, any of methods shown in FIGS. 4A-4C may be governed by instructions that are stored in a computer readable storage medium and that are executed by one or more processors of one or more servers. The computer readable storage medium may include a magnetic or optical disk storage device, solid state storage devices such as flash memory, or other non-volatile memory device or devices. The computer readable instructions stored on the computer readable storage medium are in source code, assembly language code, object code, or other instruction format that is interpreted by one or more processors.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method, comprising:
at a server,
receiving an email message that is addressed to a recipient communication device, wherein the addressing information includes a phone number associated with the recipient communication device;
if no email account is associated with the recipient communication device, automatically creating an email account associated with the recipient communication device;
storing the email message for the email account;
causing an SMS to be sent to the recipient communication device, the SMS including a notification that the email message has been received and including a selectable link for accessing the email message; and
in response to receiving a selection of the selectable link, providing access to the email message.

2. The method of claim 1, wherein access is provided to the email account.

3. The method of claim 1, wherein the SMS includes information including an indication of the sender.

4. The method of claim 3, wherein the indication includes at least one of: a name associated with an email address used by the sender to send the email message, the email address used by the sender to send the email message, and a phone number associated with a communication device used by the sender to send the email message.

5. The method of claim 1, wherein the SMS includes an indication of a duration for which the email message is accessible by the recipient.

6. The method of claim 1, further comprising enabling a user of the recipient communication device to register other email mailboxes with the account for accessing by the user.

7. The method of claim 1, further comprising using the phone number to determine if an email account is associated with the recipient communication device.

8. The method of claim 1, wherein the addressing information does not include information indicative of a network carrier associated with the recipient communication device.

9. The method of claim 1, further comprising enabling the recipient communication device to restrict incoming emails to emails from formally identified senders.

10. The method of claim 1, further comprising enabling the recipient communication device to restrict incoming emails to emails from senders included in a contact list associated with the email account.

11. The method of claim 1, wherein the link is user-selectable.

12. The method of claim 1, wherein the link is automatically activated by a messaging application at the recipient communication device that receives the SMS.

13. The method of claim 1, wherein automatically creating the email account includes:
opening a new record in a user account database; and
storing the phone number associated with the recipient communication device in the new record.

14. A computer readable storage medium storing one or more programs configured for execution by a computer, the one or more programs comprising instructions for:
receiving an email message that is addressed to a recipient communication device, wherein the addressing information includes a phone number associated with the recipient communication device;
if no email account is associated with the recipient communication device, automatically creating an email account associated with the recipient communication device;
storing the email message for the email account;
causing an SMS to be sent to the recipient communication device, the SMS including a notification that the email message has been received and including a selectable link for accessing the email message; and
in response to receiving a selection of the selectable link, providing access to the email message.

15. A computer-implemented method, comprising:
at a recipient communication device,
receiving an SMS, the SMS including a notification that an email message has been received and including a selectable link for accessing the email message, wherein the email message is addressed to the recipient communication device using addressing information that includes a phone number associated with the recipient communication device; and
in response to receiving a selection of the selectable link, accessing a web page that provides access to an email account containing the email message, wherein the email account is created automatically and is associated with the phone number associated with the recipient communication device.
